(19) United States
(12) Patent Application Publication
(10) Pub. No.: US 2008/0115202 A1
(43) Pub. Date: May 15, 2008

(54) METHOD FOR BIDIRECTIONAL COMMUNICATION IN A FIREWALLED ENVIRONMENT

(76) Inventor: Michael S. McKay, Round Rock, TX (US)

Correspondence Address: IBM CORP. (CLG);c/o CARDINAL LAW GROUP, 1603 ORRINGTON AVENUE, SUITE 2000, EVANSTON, IL, 60201, US

(21) Appl. No.: 11/558,135

(22) Filed: Nov. 9, 2006

(51) Int. Cl. G06F 21/20

(52) U.S. Cl. 726/12

(57) ABSTRACT

A method of bidirectional communication through a firewall includes opening a command channel across the firewall between a gateway manager within a secure network and a gateway service and receiving a resource request via the command channel from the gateway service at the gateway manager. The method further includes determining a resource within the secure network and an agent associated with the resource request, sending a resource access notification from the gateway manager to the determined resource, and receiving a resource communication from the associated resource responsive to the notification. The method further includes tying the associated resource to the agent based on the resource communication.

### FIELD OF INVENTION

The present invention generally relates to communications. More specifically, the invention relates to bidirectional communications across a firewall.

### BACKGROUND OF THE INVENTION

Network security is a daunting challenge for network administrators. The administrator must keep the networks open enough to satisfy operational demands, while secure enough to maintain a high degree of security. Typically, administrators operate a firewall to limit communications into and out of a secured network. Computer networks and devices “behind” the firewall are protected from undesired communications, while computer networks “outside” the firewall are not protected by the firewall and are considered “unsecured” Computer networks outside the firewall may be protected by a firewall, but are considered unsecure since the level of protection is unknown.

Historically, firewalled networks are difficult to traverse from a central location outside the firewall. This difficulty is enhanced by a common firewall policy that disallows connections from outside the firewall, and only allows connections from inside the firewall. In other words, many firewalls do not allow connections to a secured network from an unsecured network.

This inability to connect to a resource within a secured network has been previously addressed with the use of proxies. These proxy solutions rely on the secured network polling for connection requests from the unsecured network. While generally effective, such polling is complicated and can be slow. Additionally, this solution does not scale well.

It is therefore a challenge to develop a method to provide bidirectional communication to overcome these, and other, disadvantages.

### SUMMARY OF THE INVENTION

A first embodiment of the invention includes a method of bidirectional communication through a firewall. The method includes opening a command channel across the firewall between a gateway manager within a secure network and a gateway service and receiving a resource request via the command channel from the gateway service at the gateway manager. The method further includes determining a resource within the secure network and an agent associated with the resource request, sending a resource access notification from the gateway manager to the determined resource, and receiving a resource communication from the associated resource responsive to the notification. The method further includes tying the associated resource to the agent based on the resource communication.

The foregoing embodiment and other embodiments, objects, and aspects as well as features and advantages of the present invention will become further apparent from the following detailed description of various embodiments of the present invention. The detailed description and drawings are merely illustrative of the present invention, rather than limiting the scope of the present invention being defined by the appended claims and equivalents thereof.

### BRIEF DESCRIPTION OF THE DRAWINGS

FIG. 1 illustrates one embodiment of a computer client, in accordance with one aspect of the invention;

FIG. 2 illustrates one embodiment of a network system for use in accordance with one aspect of the invention

FIG. 3 illustrates one embodiment of a method for bidirectional communication through a firewall, in accordance with one aspect of the invention;

FIG. 4A schematically illustrates one embodiment of a system for bidirectional communication through a firewall, in accordance with one aspect of the invention;

FIG. 4B schematically illustrates one embodiment of a system for bidirectional communication through a firewall, in accordance with one aspect of the invention;

FIG. 5 illustrates one embodiment of a method for bidirectional communication through a firewall, in accordance with one aspect of the invention;

FIG. 6 illustrates one embodiment of a method for bidirectional communication through a firewall, in accordance with one aspect of the invention; and

FIG. 7 illustrates one embodiment of a method for bidirectional communication through a firewall, in accordance with one aspect of the invention.

### DETAILED DESCRIPTION OF THE PRESENT INVENTION

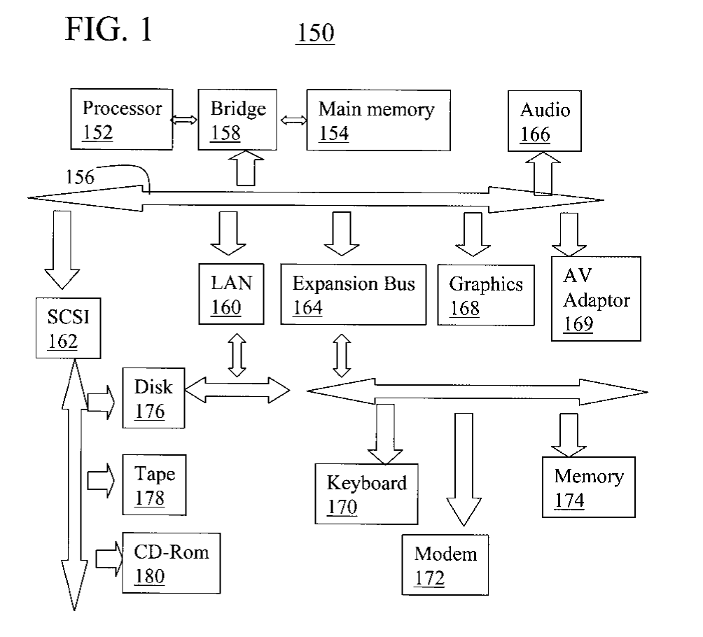

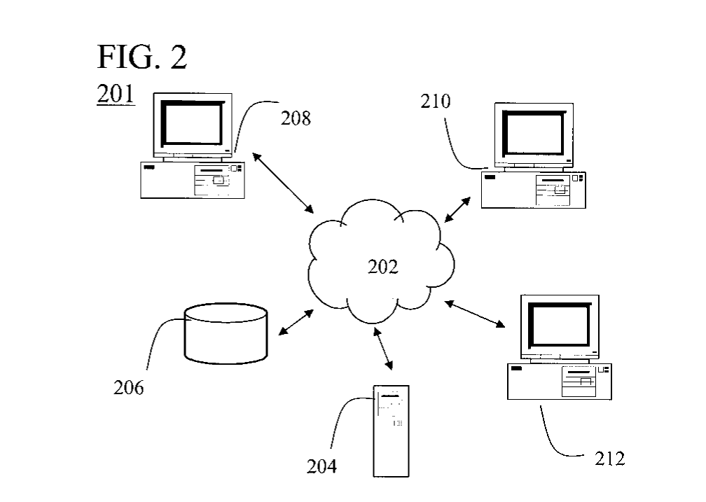

FIG. 1 illustrates one embodiment of a computer client 150 for use in accordance with one aspect of the invention. Computer system 150 is an example of a client computer, such as clients 208, 210, and 212 (FIG. 2). Computer system 150 employs a peripheral component interconnect (PCI) local bus architecture. Although the depicted example employs a PCI bus, other bus architectures such as Micro Channel and ISA may be used. PCI bridge 158 connects processor 152 and main memory 154 to PCI local bus 156. PCI bridge 158 also may include an integrated memory controller and cache memory for processor 152. Additional connections to PCI local bus 156 may be made through direct component interconnection or through add-in boards. In the depicted example, local area network (LAN) adapter 160, SCSI host bus adapter 162, and expansion bus interface 164 are connected to PCI local bus 156 by direct component connection. In contrast, audio adapter 166, graphics adapter 168, and audio/video adapter (A/V) 169 are connected to PCI local bus 156 by add-in boards inserted into expansion slots. Expansion bus interface 164 connects a keyboard and mouse adapter 170, modem 172, and additional memory 174 to bus 156. SCSI host bus adapter 162 provides a connection for hard disk drive 176, tape drive 178, and CD-ROM 180 in the depicted example. In one embodiment, the PCI local bus implementation support three or four PCI expansion slots or add-in connectors, although any number of PCI expansion slots or add-in connectors can be used to practice the invention.

An operating system runs on processor 152 to coordinate and provide control of various components within computer system 150. The operating system may be any appropriate available operating system such as Windows, Macintosh, UNIX, LINUX, or OS/2, which is available from International Business Machines Corporation. “OS/2” is a trademark of International Business Machines Corporation. Instructions for the operating system, an object-oriented operating system, and applications or programs are located on storage devices, such as hard disk drive 176 and may be loaded into main memory 154 for execution by processor 152.

Those of ordinary skill in the art will appreciate that the hardware in FIG. 1 may vary depending on the implementation. For example, other peripheral devices, such as optical disk drives and the like may be used in addition to or in place of the hardware depicted in FIG. 1. FIG. 1 does not illustrate any architectural limitations with respect to the present invention, and rather merely discloses an exemplary system that could be used to practice the invention. For example, the processes of the present invention may be applied to multiprocessor data processing system.

FIG. 2 illustrates an exemplary network system 201. Network system 201 is illustrative only, and is not an architectural limitation for the practice of this invention. Network system 201 is a network of computers in which the present invention may be implemented. Network system 201 includes network 202, which is the medium used to provide communications links between various devices and computers connected together within distributed network system 201. Network 202 may include permanent connections, such as wire or fiber optic cables, or temporary connections made through telephone connections. In other embodiments, network 202 includes wireless connections using any appropriate wireless communications protocol including short range wireless protocols such as a protocol pursuant to FCC Part 15, including 802.11, Bluetooth or the like, or a long range wireless protocol such as a satellite or cellular protocol.

In FIG. 2, a server 204 is connected to network 202 along with storage unit 206. In addition, clients 208, 210, and 212 also are connected to a network 202. These clients 208, 210, and 212 may be, for example, personal computers or network computers. For purposes of this application, a network computer is any computer, coupled to a network, which receives a program or other application from another computer coupled to the network. In the depicted example, server 204 provides data, such as boot files, operating system images, and applications to clients 208-212. Clients 208, 210, and 212 are clients to server 204. Network system 201 may include additional servers, clients, and other devices not shown. In the depicted example, network system 201 is the Internet with network 202 representing a worldwide collection of networks and gateways that use the TCP/IP suite of protocols to communicate with one another. Network system 201 also may be implemented as a number of different types of networks, such as for example, an intranet or a local area network.

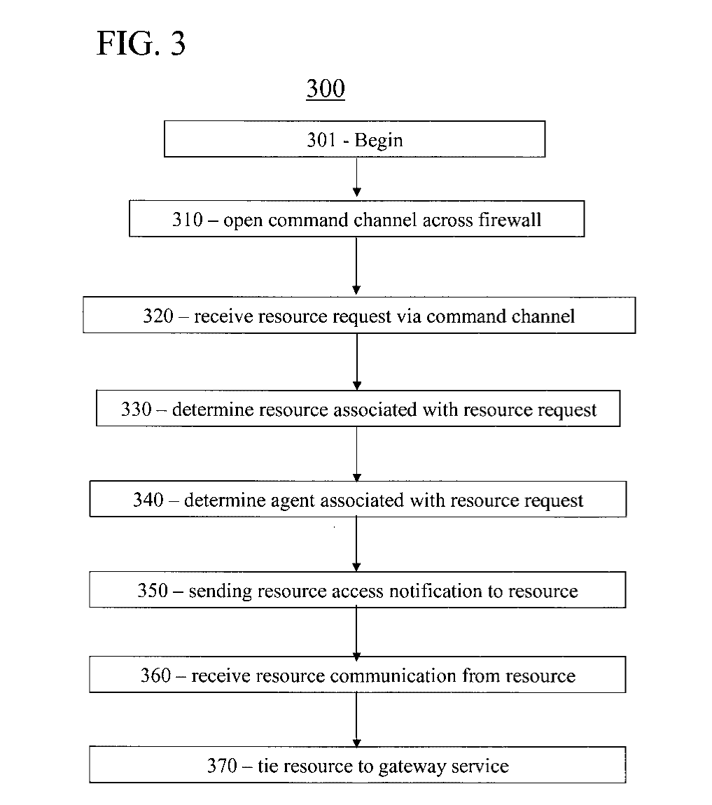

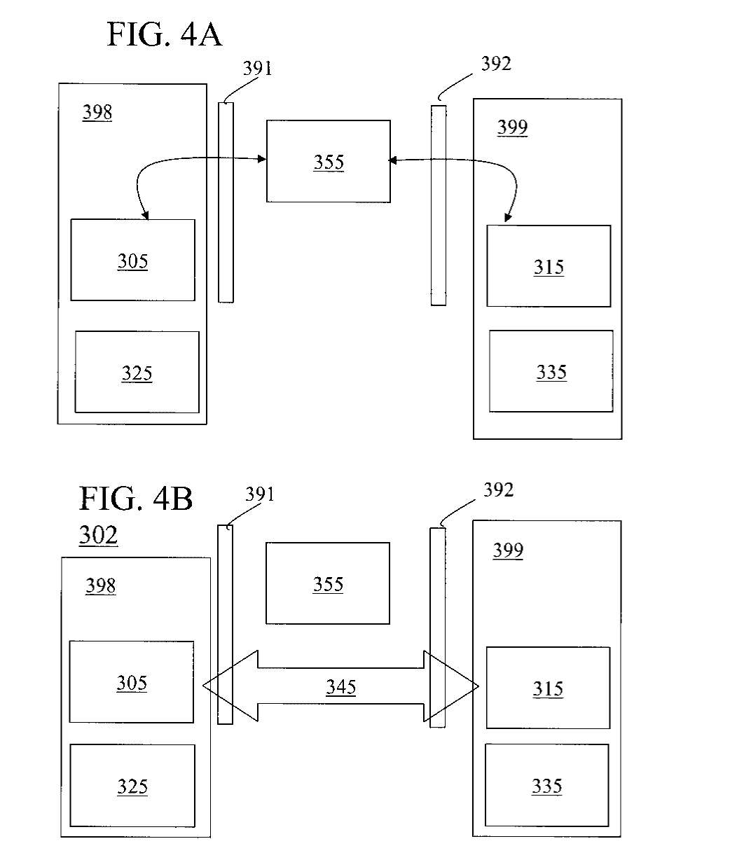

FIG. 3 illustrates one embodiment of a method 300 for bidirectional communication through a firewall, in accordance with one aspect of the invention. Method 300 begins at 301. At step 310, a command channel 345 (FIG. 4B) is opened across a firewall 391, 392 between a gateway manager 305 within a secure network 398 and a gateway service 315. Gateway service 315 is in an unsecured network 399. In one embodiment, the command channel 345 is opened using at least one proxy relay 355, as shown in FIG. 4A. Any appropriate proxy technique can be used to open the command channel 345. Secure network 398 is separated from the unsecured network by firewall 391. In one example, gateway service 315 is connected to outside networks through at least one firewall 392. In one embodiment, communications described herein operate using a TCP/IP protocol. Alternatively, the communications can operate using any appropriate packet data protocol or other such network communication protocol or device. After opening the command channel, method 300 maintains the command channel in an open state. Maintaining the command channel is defined as keeping the command channel open in the absence of traffic across the command channel for a non-transient time span. A non-transient time span is a span of time in excess of the span of time required to open a new command channel.

Having opened the command channel 345 (FIG. 4B), gateway manager 305 receives a resource request via command channel 345 from the gateway service 315 at step 320. The resource request is a request to access at least one resource behind gateway manager 305 and firewall 391. The resource can be any hardware or software such as data, processing resource, application, or the like.

The gateway manager 305 determines at least one resource 325 within the secure network 398 associated with the resource request at step 330. The determination can include parsing the request to identify the resource. Additionally, in one embodiment, determining the resource includes determining at least one network address of the resource associated with the resource request and determining availability of the resource. Determining availability can include pinging the resource to determine a status of the resource, as well as determining network conditions (such as congestion, distance, etc.) between the resource and gateway manager, and selecting one of a plurality of similar resources if appropriate.

At least one agent 335 associated with the resource request is determined at step 340. Agent 335 is any software or hardware residing on a network behind firewall 392 that intends to access a resource, such as resource 325 residing behind firewall 391. The determination of the agent is based on a particular request encoded in the resource request, in one embodiment. In another embodiment, the determination is responsive to at least one characteristic encoded in the resource request. In one embodiment, the resource request includes at least one port number on which the agent intends to communicate with the resource. The encoded characteristic can be, for example, an address, a name, a functional description, or the like.

Gateway manager 305 sends a resource access notification to the determined resource at step 350. The resource access notification is a message requesting formation of a connection from the gateway manager 305 to the resource 325.

A resource communication is received at the gateway manager from the resource at step 360. The resource communication is a message encoded with information relating to the availability of the resource. In one embodiment, the information includes a port number on which the resource will communicate with the agent.

The gateway manager ties the resource to the gateway service based on the resource communication at step 370. Tying the resources allows the agent to have largely unrestricted access to the resource.

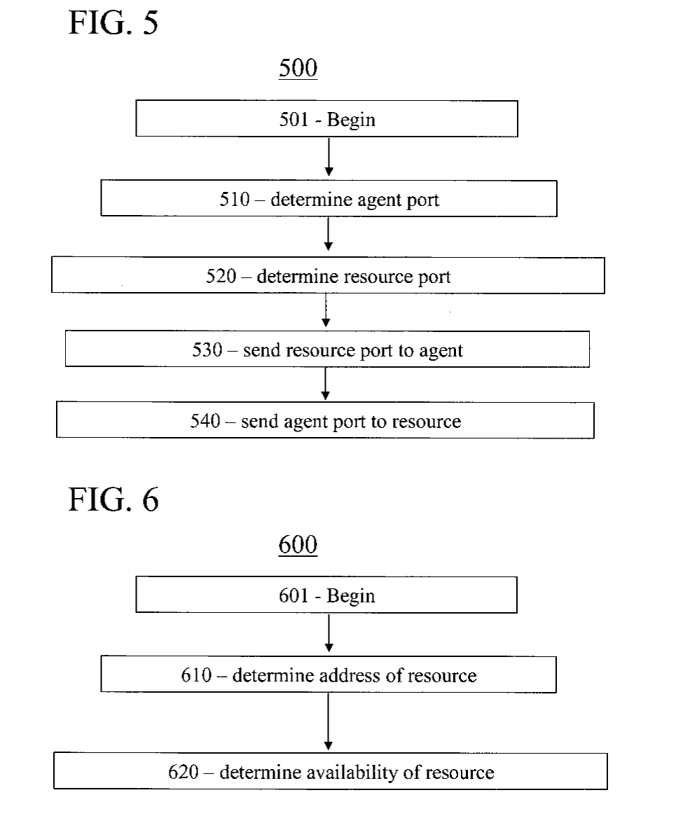

FIG. 5 illustrates one embodiment of a method 500 for bidirectional communication through a firewall. Method 500 is implemented during execution of method 300 in certain embodiments. Method 500 begins at 501, and continues at step 510 by determining the agent port. The agent port is a port on which the agent wishes to communicate with the desired resource. The gateway manager can determine the agent port polling the agent to determine the agent port, or by decoding the resource request to determine if the agent port is included in the resource request.

The gateway manager further determines a resource port based on the resource communication at step 520. The resource port is a port on which the resource will communicate with the agent. The gateway manager can determine the resource port polling the resource to determine the resource port, or by decoding the resource communication to determine if the resource port is included in the resource communication.

Having determined the resource port and agent port, the gateway manager then sends the resource port to the agent at step 530 and sends the agent port to the resource at step 540. Communications thereafter between the agent and resource can be directed to the appropriate port, expediting transmission through the firewall and gateway manager.

FIG. 6 illustrates one embodiment of a method 600 for determining a resource associated with a resource request, in accordance with one aspect of the invention. Method 600 begins at 601, and the address of the resource is determined at step 610. Determining the address can include polling a network, parsing the resource request to determine if the address is included in the resource request, or by consulting a lookup table. Other appropriate methods of determining a resource address can also be used.

Having determined the address, method 600 then determines availability of the resource at step 620. Availability of the resource can be affected by resource usage, network usage, network conditions, network congestion, physical distance between devices or other factors.

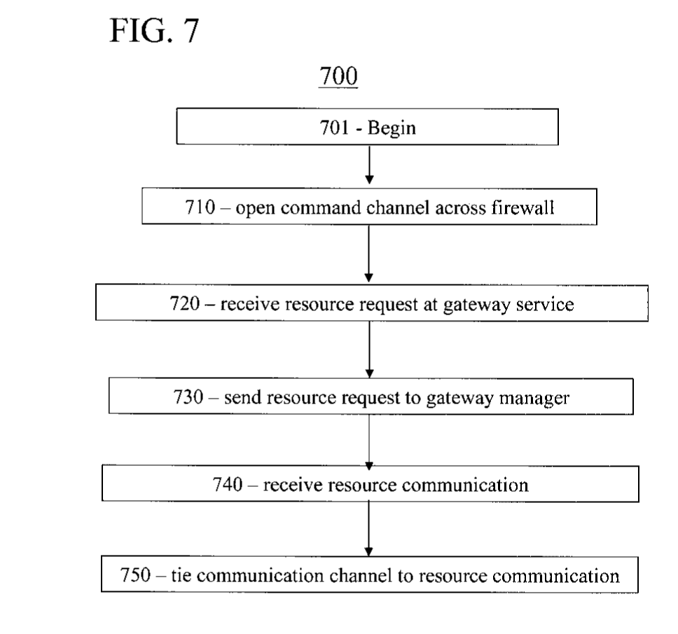

FIG. 7 illustrates one embodiment of a method 700 for bidirectional communication through a firewall, in accordance with one aspect of the invention. Method 700 begins at 701. At step 710, a command channel 345 (FIG. 4B) is opened across a firewall 391, 392 between a gateway service 315 and a gateway manager 305 within a secure network 398. In one embodiment, the command channel 345 is opened using at least one proxy relay 355, as shown in FIG. 4A. Any appropriate proxy technique can be used to open the command channel 345. Secure network 398 is separated from the unsecured network by firewall 391. In one example, gateway service 315 is connected to outside networks through at least one firewall 392. In one embodiment, communications described herein operate using a TCP/IP protocol. Alternatively, the communications can operate using any appropriate packet data protocol or other such network communication protocol or device.

The gateway service receives a resource request at step 720. The resource request is implemented, for example, in a similar fashion as in step 320. The resource request is sent to the gateway manager via the command channel at step 730. After sending the resource request, the gateway service receives a resource communication from the gateway manager at step 740. The resource communication includes at least one communication tied to the resource associated with the resource request or a denial of connection. Based on receiving a tied communication, the gateway service ties a communication between the agent and the gateway manager at step 750.

Use of the methods described herein result in the formation of a virtual connection between the agent and resource via the tied communications. This virtual connection extends through the firewall isolating the resource from unsecured networks. Each tied connection operates so that the connection in and connection out behave as a single connection.

The invention can take the form of an entirely hardware embodiment, an entirely software embodiment, or an embodiment containing both hardware and software elements. In a preferred embodiment, the invention is implemented in software, which includes but is not limited to firmware, resident software, microcode, etc. Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device), or a propagation medium such as a carrier wave. Examples of a computer-readable medium include a semiconductor or solid-state memory, magnetic tape, a removable computer diskette, a random access memory (RAM), a read-only memory (ROM), a rigid magnetic disk and an optical disk.

While the embodiments of the present invention disclosed herein are presently considered to be preferred embodiments, various changes and modifications can be made without departing from the spirit and scope of the present invention. The scope of the invention is indicated in the appended claims, and all changes that come within the meaning and range of equivalents are intended to be embraced therein.

I claim:

1. A method of bidirectional communication through a firewall, the method comprising:
opening a command channel across the firewall between a gateway manager within a secure network and a gateway service;
maintaining the command channel;
receiving a resource request via the command channel from the gateway service at the gateway manager;
determining a resource associated with the resource request, the resource within the secure network;
determining an agent associated with the resource request;
sending a resource access notification from the gateway manager to the determined resource;
receiving a resource communication from the associated resource responsive to the notification; and
tying the associated resource to the gateway service based on the resource communication.

2. The method of claim 1 further comprising:
determining an agent port based on the resource request;
determining a resource port based on the resource communication;
sending the resource port to the agent; and
sending the agent port to the resource.

3. The method of claim 1 wherein the communication utilizes a TCP/IP protocol.

4. The method of claim 1 wherein the command channel is opened using at least one proxy.

5. The method of claim 1 wherein determining the resource associated with the resource request comprises:
determining at least one address of the resource; and
determining availability of the resource.

6. The method of claim 1 wherein tying the associated resource to the gateway service comprises:
tying the associated resource to the agent at the gateway service.

7. The method of claim 1 wherein maintaining the command channel comprises:
maintaining the command channel in the absence of traffic across the command channel for a non-transient time span.

8. A computer readable medium including computer readable code for bidirectional communication through a firewall, the medium comprising:
computer readable code for opening a command channel across the firewall between a gateway manager within a secure network and a gateway service;
computer readable code for maintaining the command channel;
computer readable code for receiving a resource request via the command channel from the gateway service at the gateway manager;
computer readable code for determining a resource associated with the resource request, the resource within the secure network;
computer readable code for determining an agent associated with the resource request;
computer readable code for sending a resource access notification from the gateway manager to the determined resource;
computer readable code for receiving a resource communication from the associated resource responsive to the notification; and
computer readable code for tying the associated resource to the gateway service based on the resource communication.

9. The medium of claim 8 further comprising:
computer readable code for determining an agent port based on the resource request;
computer readable code for determining a resource port based on the resource communication;
computer readable code for sending the resource port to the agent; and
computer readable code for sending the agent port to the resource.

10. The medium of claim 8 wherein the communication utilizes a TCP/IP protocol.

11. The medium of claim 8 wherein the command channel is opened using at least one proxy.

12. The medium of claim 8 wherein computer readable code for determining the resource associated with the resource request comprises:
computer readable code for determining at least one address of the resource; and
computer readable code for determining availability of the resource.

13. The medium of claim 8 wherein computer readable code for tying the associated resource to the gateway service comprises:
computer readable code for tying the associated resource to the agent at the gateway service.

14. The medium of claim 8 wherein computer readable code for maintaining the command channel comprises:
means for maintaining the command channel in the absence of traffic across the command channel for a non-transient time span.

15. A method of bidirectional communication through a firewall, the method comprising:
opening a command channel across the firewall between a gateway manager within a secure network and a gateway service;
maintaining the command channel;
receiving a resource request from an agent at the gateway service, the resource request associated with a resource in the secure network;
sending the resource request via the command channel from the gateway service to the gateway manager;
receiving a resource communication from the gateway manager responsive to the resource request, the resource communication including a tied connection between the gateway manager and the resource; and
tying a communication channel from the agent to the resource communication.

16. The method of claim 15 further comprising:
determining an agent port based on the resource request; and
sending the agent port to the resource.

17. The method of claim 15 wherein maintaining the command channel comprises:
maintaining the command channel in the absence of traffic across the command channel for a non-transient time span.

18. The method of claim 15 wherein the command channel is opened using at least one proxy.
